(19) United States
(12) Patent Application Publication
(10) Pub. No.: US 2021/0325616 A1
(43) Pub. Date: Oct. 21, 2021

(54) PLUGGABLE OPTICAL MODULE CAGE FOR FIXED HEAT SINK

(71) Applicant: Adtran, Inc., Huntsville, AL (US)

(72) Inventors: Adam Keith LANDS, New Market, AL (US); Jon M. CHALMERS, Madison, AL (US); Grant J. KRUSE, Owens Cross Roads, AL (US)

(21) Appl. No.: 17/230,025

(22) Filed: Apr. 14, 2021

Related U.S. Application Data
(60) Provisional application No. 63/011,347, filed on Apr. 17, 2020.

(51) Int. Cl. G02B 6/42

(52) U.S. Cl. CPC G02B 6/4269; G02B 6/4278; G02B 6/428; G02B 6/4261

(57) ABSTRACT

An electronic module cage for receiving an electronic module (such as a pluggable optical module (POM)), includes a cage body mounted to a printed circuit board (PCB), the cage body having a first opening configured to receive an electronic module, the cage body comprising a spring feature, the spring feature configured to apply a biasing pressure to the electronic module in a direction away from the printed circuit board and toward a heat dissipating element such that a surface of the electronic module contacts the heat dissipating element through a second opening in the cage body.

### RELATED APPLICATIONS

The present application claims priority to and the benefit of the filing date of U.S. Provisional Application No. 63/011,347, entitled “Pluggable Optical Module Cage For Fixed Heat Sink” (Attorney Docket No. 01070.0051U1 (19-022)) filed on Apr. 17, 2020, the contents of which are hereby incorporated herein by reference in its entirety as if fully set forth below and for all applicable purposes.

### BACKGROUND

Electronic equipment may be enclosed within a generally box-shaped chassis, housing, or similar enclosure. Such an enclosure may be configured to retain one or more removable modules, such as, for example, an electronic module such as a pluggable optical module (POM). A POM may comprise one of a number of different form factors, such as, for example only, a small form factor pluggable transceiver (SFP and SFP+), a quad form factor pluggable transceiver (QSFP and QSFP+), a 10 Gigabit small form factor pluggable transceiver (XFP), etc. A POM may be configured to fit within a cage or other housing. One or more of the cages, or housings, may be located on a printed circuit board in the enclosure.

A POM generates heat and is generally coupled to a heat sink, or a heat sinking element. A heat sink may be attached to a cage and a POM using a number of attachment methods, such as, for example only, a sheet metal spring that forces the heat sink downward into contact with the transceiver. This “floating” attachment method only allows each transceiver or POM one individual heat sink to be used for convective cooling purposes.

A POM that is allowed to exceed a maximum rated temperature (typically 70°-85° C.) will experience performance degradation and possible total failure to operate. With power dissipation of a POM increasing, heat sinking methods for these modules are becoming more challenging.

Current available POM cages that integrate a heat sink limit the amount of heat that is able to be dissipated from the module. These existing integrated heat sink cages generally comprise a pin-fin or a blade-fin variety that provide only convective cooling to the POM. If an existing integrated heat sink cage cannot provide adequate cooling to a POM with the given design space and airflow allowances, costly non-traditional cooling strategies must be implemented.

Therefore, it would be desirable for a POM cage to have the ability to provide sufficient cooling without the need to incorporate costly non-traditional cooling strategies.

### SUMMARY

In an exemplary embodiment, an electronic module cage for receiving an electronic module (such as a pluggable optical module (POM)) includes a cage body mounted to a printed circuit board (PCB), the cage body having a first opening configured to receive an electronic module, the cage body comprising a spring feature, the spring feature configured to apply a biasing pressure to the electronic module in a direction away from the printed circuit board and toward a heat dissipating element such that a surface of the electronic module contacts the heat dissipating element through a second opening in the cage body.

In another exemplary embodiment, an electronic module cage for receiving an electronic module (such as a pluggable optical module (POM)) includes a cage body mounted to a printed circuit board (PCB), the cage body having a first opening configured to receive an electronic module, the cage body comprising a spring feature, the spring feature configured to apply a biasing pressure in a direction away from the printed circuit board and toward a heat dissipating element, the heat dissipating element having a portion that extends or protrudes through a second opening in a surface of the cage body.

In another exemplary embodiment, an electronic assembly includes a printed circuit board (PCB) having an electronic module cage mounted thereon, the printed circuit board (PCB) having a heat dissipating element mounted thereon, the electronic module cage having a cage body having a first opening configured to receive an electronic module (such as a pluggable optical module (POM)), the cage body comprising a spring feature, the spring feature configured to apply a biasing pressure to the electronic module in a direction away from the printed circuit board (PCB) and toward the heat dissipating element such that a surface of the electronic module directly contacts the heat dissipating element through a second opening in the cage body.

In another exemplary embodiment, an electronic assembly includes an electronic assembly housing, a printed circuit board (PCB) having an electronic module cage mounted thereon, the electronic module cage having a cage body having an opening configured to receive an electronic module (such as a pluggable optical module (POM)), the cage body comprising a spring feature, the spring feature configured to apply a biasing pressure to the electronic module in a direction away from the printed circuit board (PCB) and toward the electronic assembly housing, the electronic assembly housing configured as a heat dissipating element wherein a surface of the electronic module directly contacts the electronic assembly housing.

In another exemplary embodiment, an electronic assembly includes an electronic assembly housing, and a printed circuit board (PCB) having an electronic module cage mounted thereon, the electronic module cage having a cage body having an opening configured to receive an electronic module (such as a pluggable optical module (POM)), the cage body comprising a spring feature, the spring feature configured to apply a biasing pressure to the electronic module in a direction away from the printed circuit board (PCB) and toward the electronic assembly housing, the electronic assembly housing configured as a heat dissipating element wherein a portion of the electronic assembly housing extends or protrudes through a second opening in the cage body.

In another exemplary embodiment, an electronic assembly includes a printed circuit board (PCB) having an electronic module cage mounted thereon, the printed circuit board (PCB) having a heat dissipating element mounted thereon, the electronic module cage having a cage body having a first side and a second side configured to receive an electronic module (such as a pluggable optical module (POM)), the cage body comprising a spring feature, the spring feature configured to apply a biasing pressure to the electronic module in a direction away from the printed circuit board (PCB) and toward the heat dissipating element such that a surface of the electronic module directly contacts the heat dissipating element wherein the heat dissipating element forms an upper surface of the electronic module cage.

Other systems, methods, features, and advantages will be or become apparent to one with skill in the art upon examination of the following figures and detailed description. It is intended that all such additional systems, methods, features, and advantages be included within this description, be within the scope of the specification, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 shows a drawing of a pluggable optical/electronic module cage having a cage body and a spring feature.

FIG. 2 shows a drawing of an electronic assembly having a plurality of pluggable optical/electronic module cages.

FIG. 3 shows a drawing of an electronic assembly in which the heat dissipating element is affixed to the printed circuit board directly over the plurality of pluggable optical/electronic module cages.

FIG. 4 shows a drawing of an electronic assembly.

FIG. 5 shows a drawing of the pluggable optical/electronic module cage of FIG. 1.

FIG. 6 shows a drawing of a portion of the electronic assembly of FIG. 2.

FIG. 7 shows a drawing of a portion of an alternative exemplary embodiment of an electronic assembly.

FIG. 8 shows a drawing of a portion of the electronic assembly of FIG. 7.

FIG. 9 shows a drawing of a portion of the electronic assembly of FIG. 7.

FIG. 10 shows a drawing of a portion of an alternative exemplary embodiment of an electronic assembly.

FIG. 11 shows a drawing of the portion of the electronic assembly of FIG. 10 in an assembled state.

FIG. 12 shows a drawing of a portion of an alternative exemplary embodiment of an electronic assembly.

### DETAILED DESCRIPTION

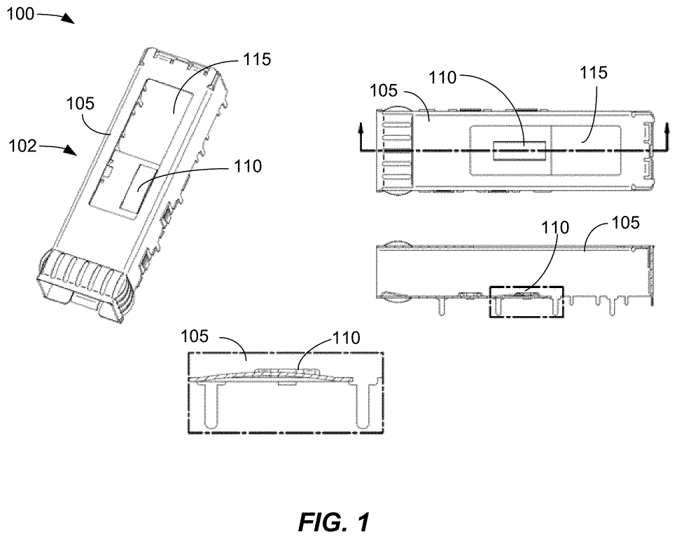

FIG. 1 shows a drawing 100 of a pluggable optical/electronic module cage 102 having a cage body 105 and a spring feature 110. The cage body 105 includes an opening 115 through which a heat dissipating element (not shown) or a portion of a heat dissipating element may extend or protrude to directly contact an electronic module (not shown) such as a pluggable optical module (POM) inserted in the pluggable optical/electronic module cage 102.

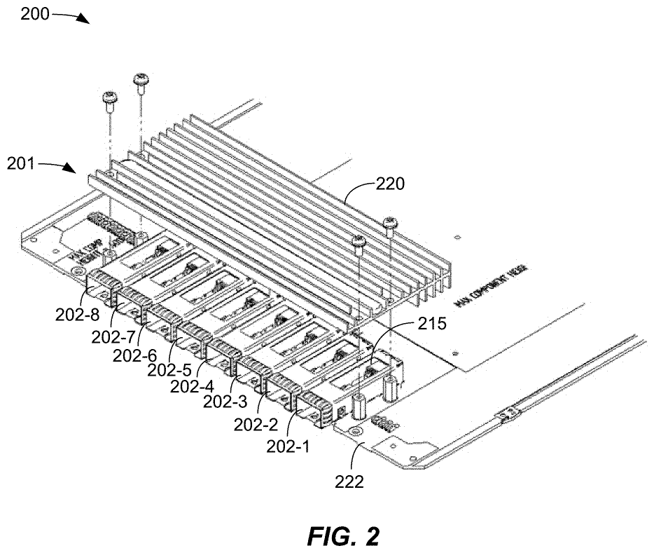

FIG. 2 shows a drawing 200 of an electronic assembly 201 having a plurality of pluggable optical/electronic module cages, exemplary ones of which are shown using reference numerals 202-1 through 202-8. In an exemplary embodiment, the plurality of pluggable optical/electronic module cages 202 may be affixed to a printed circuit board 222. A heat dissipating element 220 may be located over the plurality of pluggable optical/electronic module cages 202 and may be solidly affixed or otherwise mounted to the printed circuit board 222. A portion of the heat dissipating element 220 may extend or protrude through the opening 215 in the pluggable optical/electronic module cage 202 to directly contact an electronic module (not shown) in the electronic module cage 202. Moreover, the heat dissipating element 220 may include multiple portions that may extend into respective openings 215 in some or all of the pluggable optical/electronic module cages 202-1 through 202-8 to directly contact respective electronic modules (not shown) in one or more of the electronic module cages 202-1 through 202-8.

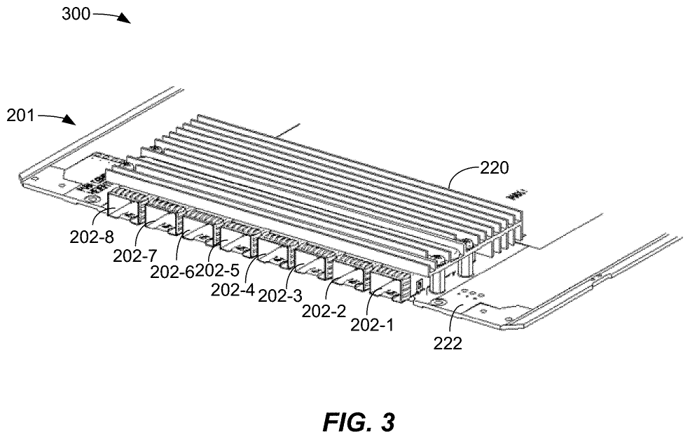

FIG. 3 shows a drawing 300 of the electronic assembly 201 in which the heat dissipating element 220 is affixed to the printed circuit board 222 directly over the plurality of pluggable optical/electronic module cages 202-1 through 202-8. Referring to FIG. 1, FIG. 2 and FIG. 3, in an exemplary embodiment, the spring feature 110 (FIG. 1) in the pluggable optical/electronic module cage 102 (FIG. 1) may be configured to assert an upward pressure on an electronic module (not shown) inserted in the pluggable optical/electronic module cage 102, 202 such that a surface of the electronic module (not shown) is biased, or pressed, directly upwardly, away from the printed circuit board 222, against at least a portion of the heat dissipating element 220 that may extend into respective openings 215 in some or all of the pluggable optical/electronic module cages 202-1 through 202-8 to directly contact respective electronic modules (not shown) in one or more of the electronic module cages 202-1 through 202-8.

A fixed, rigid heat dissipating element 220 allows a circuit designer more freedom to use complex, high performance heat dissipation solutions (e.g. heat pipes, purely conductive cooling, thermoelectric coolers, etc.) that would not otherwise be feasible with traditional heat sink attachment methods. The traditional method of attaching a heat sinking element to an optic cage assembly only allows for one single isolated heat sinking element to be utilized above each module slot in the cage. This “floating” heat sink strategy is done to allow for variances in the module case that acts as the primary heat sinking surface. Adjacent module case surfaces are often not co-planar therefore a single “floating” heat sink over each module is used to conform and mate more completely to each module case.

The direct contact of the fixed heat sink path between an electronic module (not shown in FIG. 3) and the heat dissipating element 220 allows the use of higher performing thermal solutions to cool the electronic module (not shown in FIG. 3) than what is traditionally offered off the shelf. An example of a higher performing heat dissipation solution is shown in FIG. 3 where the heat dissipating element 220 may comprise a single extruded heat sink structure that, in the embodiment shown in FIG. 3, can cool up to eight individual electronic modules that may be inserted into the eight pluggable optical/electronic module cages 202-1 through 202-8. This example has been tested to show an approximate 7° C. increase in performance over a similar traditional heat sink solution.

Although the example shown in FIG. 3 anticipates up to eight individual electronic modules being installed in the eight pluggable optical/electronic module cages 202-1 through 202-8, the concept may be used for any number of electronic modules, including a single electronic module inserted into a single pluggable optical/electronic module cage 202.

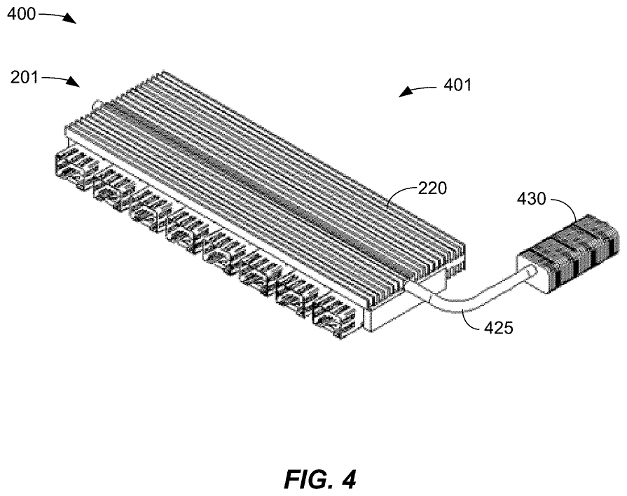

FIG. 4 shows a drawing 400 of an electronic assembly 401 including the electronic assembly 201, a heat pipe 425 coupled to the heat dissipating element 220 and an additional heat dissipating element 430 coupled to the heat pipe 425. As used herein, the term “coupled” may refer to thermal coupling, mechanical coupling, and any other coupling. The additional heat dissipating element 430 may be, for example, an active heat dissipating element such as a cooler, a fan, an evaporator, or another active heat dissipating element, as well as direct conduction to a heat sinking enclosure such as an electronics housing, as will be described below.

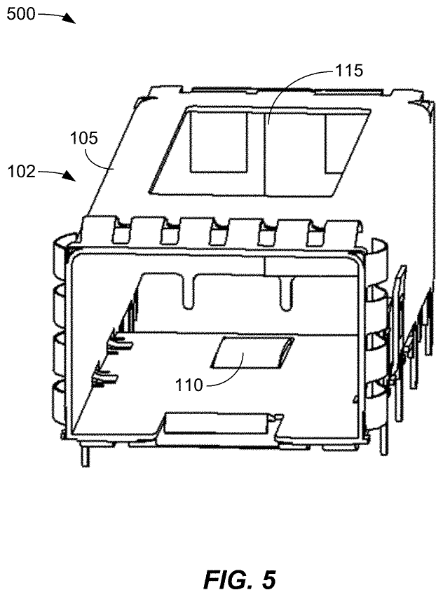

FIG. 5 shows a drawing 500 of the pluggable optical/electronic module cage 102 of FIG. 1. The drawing 500 shows a perspective view showing the cage body 105, the spring feature 110, and the opening 115. In an exemplary embodiment, the spring feature 110 exerts an upward pressure on an electronic module (not shown) toward the opening 115 that may be inserted into the pluggable optical/electronic module cage 102.

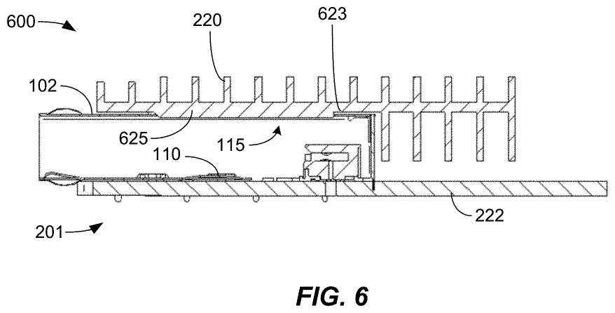

FIG. 6 shows a drawing 600 of a portion of the electronic assembly 201 of FIG. 2. The drawing 600 shows the pluggable optical/electronic module cage 102 of FIG. 1 affixed to the printed circuit board 222. The heat dissipating element 220 is also affixed to the printed circuit board 222 over the pluggable optical/electronic module cage 102. A portion 625 of the heat dissipating element 220 protrudes or extends past the surface 623 and through the opening 115 in the pluggable optical/electronic module cage 102 to directly contact an electronic module (not shown) inserted into the pluggable optical/electronic module cage 102. The spring feature 110 exerts an upward pressure, away from the printed circuit board 222 to encourage an electronic module (not shown) inserted into the pluggable optical/electronic module cage 102 upward and against the portion 625 of the heat dissipating element 220 that protrudes or extends through the opening 115.

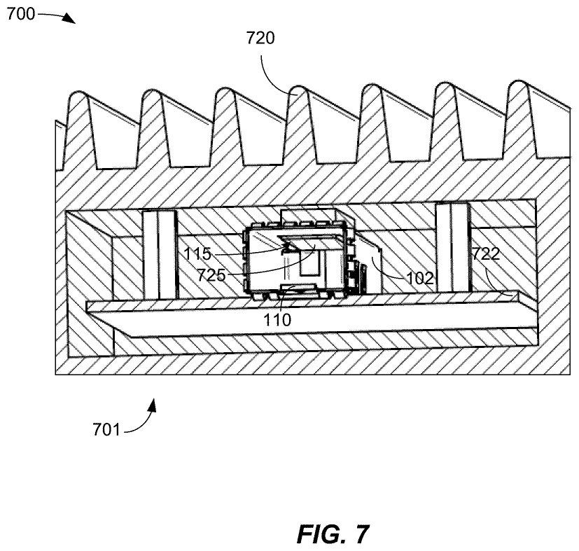

FIG. 7 shows a drawing 700 of a portion of an alternative exemplary embodiment of an electronic assembly. In FIG. 7, the electronic assembly 701 may comprise a heat dissipating element 720 that also forms the housing of the electronic assembly 701. In an exemplary embodiment, a printed circuit board 722 on which a pluggable optical/electronic module cage 102 can be mounted, may be affixed to the heat dissipating element 720. The spring feature 110 exerts an upward pressure, away from the printed circuit board 722 to encourage an electronic module (not shown) inserted into the pluggable optical/electronic module cage 102 upward and against the portion 725 of the heat dissipating element 720 that protrudes or extends through the opening 115.

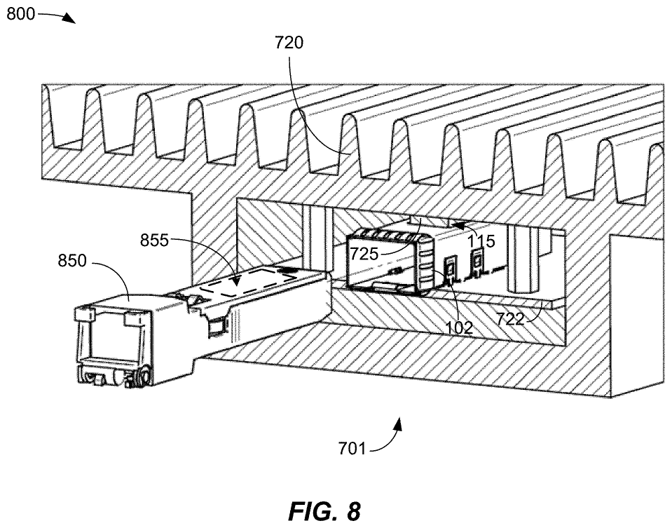

FIG. 8 shows a drawing 800 of a portion of the electronic assembly 701 of FIG. 7. In FIG. 8, an electronic module 850, such as a pluggable optical module (POM), may be inserted into the pluggable optical/electronic module cage 102. When the electronic module 850 is inserted into the pluggable optical/electronic module cage 102, the spring feature (not shown in FIG. 8) in the pluggable optical/electronic module cage 102 exerts an upward pressure on the electronic module 850, away from the printed circuit board 722 to encourage the electronic module 850 inserted into the pluggable optical/electronic module cage 102 upward and against the portion 725 of the heat dissipating element 720 that protrudes or extends through the opening (not shown) in the pluggable optical/electronic module cage 102. The approximate location of the electronic module 850 that contacts the portion 725 of the heat dissipating element 720 when the electronic module 850 is inserted into the pluggable optical/electronic module cage 102 is shown using reference numeral 855. In an exemplary embodiment, the area shown by the reference numeral 855 may be a heat generating area of the electronic module 850. In this manner, the area 855 of the electronic module 850 is pressed against and fully contacts the portion 725 of the heat dissipating element 720, thereby maximizing heat transfer from the electronic module 850 to the heat dissipating element 720.

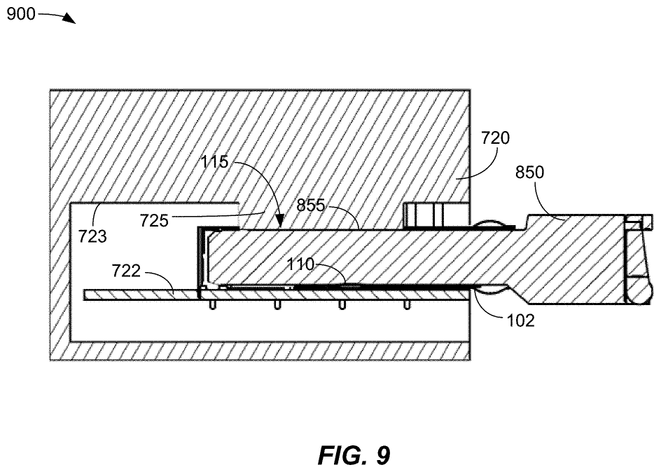

FIG. 9 shows a drawing 900 of a portion of the electronic assembly of FIG. 7. In FIG. 9, an electronic module 850, such as a pluggable optical module (POM), may be inserted into the pluggable optical/electronic module cage 102. The spring feature 110 exerts an upward pressure, away from the printed circuit board 722 to encourage the electronic module 850 inserted into the pluggable optical/electronic module cage 102 upward and against the portion 725 of the heat dissipating element 720 that protrudes or extends past the surface 723 and through the opening 115 in the pluggable optical/electronic module cage 102. The approximate location of the electronic module 850 that directly contacts the portion 725 of the heat dissipating element 720 when the electronic module 850 is inserted into the pluggable optical/electronic module cage 102 is shown using reference numeral 855. The pressure exerted by the spring feature 110 on the electronic module 850 causes the area 855 of the electronic module 850 to be pressed against and be in full contact with the portion 725 of the heat dissipating element 720, thereby maximizing heat transfer from the electronic module 850 to the heat dissipating element 720.

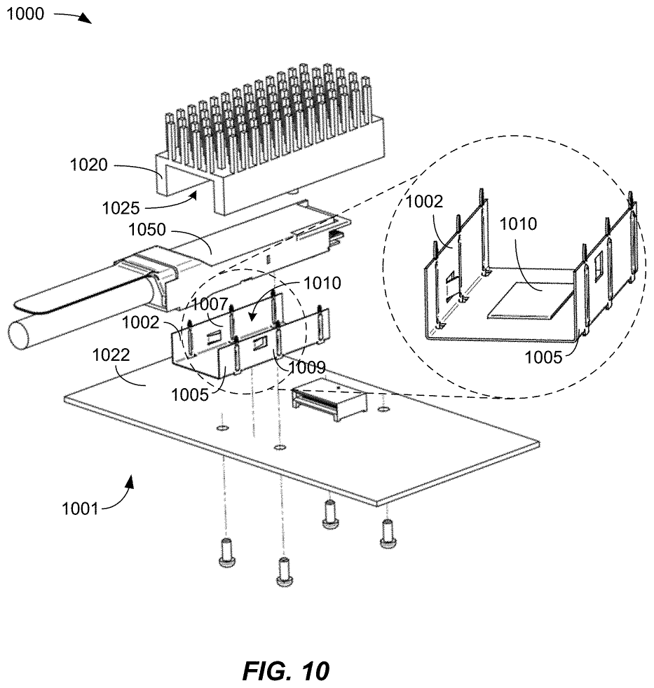

FIG. 10 shows a drawing 1000 of a portion of an alternative exemplary embodiment of an electronic assembly. In FIG. 10, the electronic assembly 1001 may comprise a printed circuit board (PCB) 1022, pluggable optical/electronic module cage 1002 having a spring feature 1010, a heat dissipating element 1020, and an electronic module 1050. In an exemplary embodiment, the pluggable optical/electronic module cage 1002 has a cage body 1005 having a first side 1007 and a second side 1009 configured to receive an electronic module (such as a pluggable optical module (POM)).

In an exemplary embodiment, the pluggable optical/electronic module cage 1002 may be mounted directly to the printed circuit board 1022 and may be open at the top such that the heat dissipating element 1020, when also mounted to the printed circuit board (PCB) 1022, forms the top of the pluggable optical/electronic module cage 1002. The spring feature 1010 may be configured to encourage the electronic module 1050 inserted into the pluggable optical/electronic module cage 1002 upward and against the underside portion 1025 of the heat dissipating element 1020 that forms the top of the pluggable optical/electronic module cage 1002.

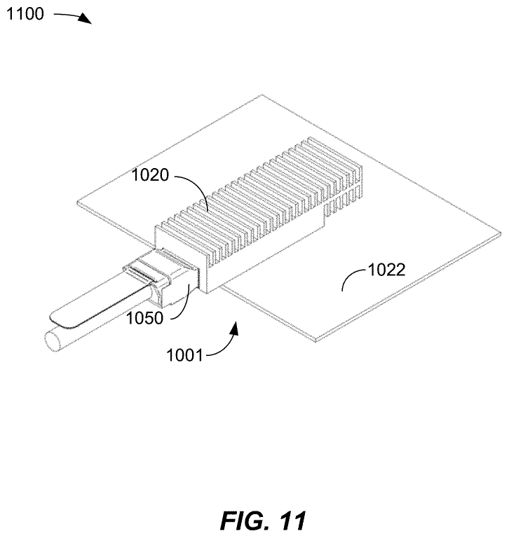

FIG. 11 shows a drawing 1100 of the portion of the electronic assembly 1001 of FIG. 10 in an assembled state. The electronic module 1050 is inserted into the pluggable optical/electronic module cage (not shown) and the heat dissipating element 1020 is affixed to the printed circuit board (PCB) 1022.

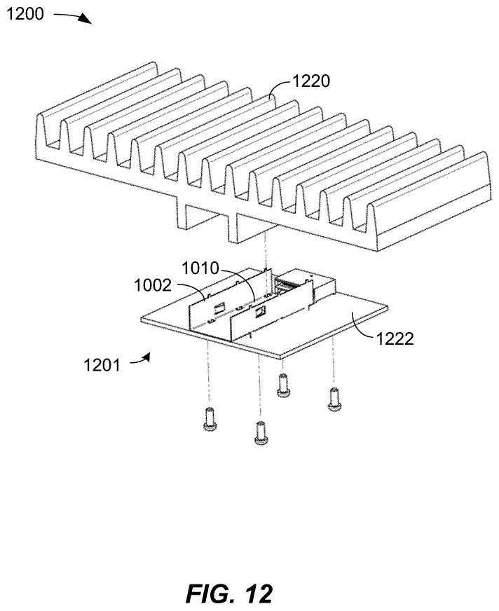

FIG. 12 shows a drawing 1200 of a portion of an alternative exemplary embodiment of an electronic assembly. In FIG. 12, the electronic assembly 1201 may comprise a printed circuit board (PCB) 1222, a pluggable optical/electronic module cage 1002 having a spring feature 1010, and a heat dissipating element 1220.

Implementation examples are described in the following numbered clauses:

1. An electronic module cage for receiving an electronic module (such as a pluggable optical module (POM)), comprising:

a cage body mounted to a printed circuit board (PCB), the cage body having a first opening configured to receive an electronic module, the cage body comprising a spring feature, the spring feature configured to apply a biasing pressure to the electronic module in a direction away from the printed circuit board and toward a heat dissipating element such that a surface of the electronic module contacts the heat dissipating element through a second opening in the cage body.

2. The electronic module cage of clause 1, wherein the spring feature biases a heat generating surface of the electronic module directly adjacent the heat dissipating element.

3. The electronic module cage of any of clauses 1-2, wherein the heat dissipating element comprises a heat sink solidly affixed to the printed circuit board to which the cage body is mounted.

4. The electronic module cage of any of clauses 1-3, further comprising an additional cage body mounted to the circuit board alongside the cage body, the additional cage body having a first opening configured to receive an additional electronic module (POM), the additional cage body comprising a spring feature, the spring feature configured to apply a biasing pressure to the additional electronic module in a direction away from the printed circuit board and toward the heat dissipating element such that a surface of the additional electronic module contacts the heat dissipating element through a second opening in the additional cage body, the heat dissipating element configured to simultaneously dissipate heat from the electronic module and from the additional electronic module.

5. The electronic module cage of any of clauses 1-4, wherein the heat dissipating element comprises a housing in which the cage body is mounted, the housing having a portion that extends or protrudes through the second opening in the cage body.

6. The electronic module cage of any of clauses 1-5, wherein the printed circuit board (PCB) and the heat dissipating element are located on opposing surfaces of the electronic module cage.

7. The electronic module cage of any of clauses 1-6, wherein the heat dissipating element is a heatsink with at least one active cooling feature.

8. An electronic module cage for receiving an electronic module (such as a pluggable optical module (POM)), comprising:

a cage body mounted to a printed circuit board (PCB), the cage body having a first opening configured to receive an electronic module, the cage body comprising a spring feature, the spring feature configured to apply a biasing pressure in a direction away from the printed circuit board and toward a heat dissipating element, the heat dissipating element having a portion that extends or protrudes through a second opening in a surface of the cage body.

9. The electronic module cage of clause 8, wherein the spring feature biases a heat generating surface of the electronic module directly adjacent the heat dissipating element.

10. The electronic module cage of any of clauses 8-9, wherein the heat dissipating element comprises a heat sink solidly affixed to the printed circuit board to which the cage body is mounted.

11. The electronic module cage of any of clauses 8-10, further comprising an additional cage body mounted to the circuit board alongside the cage body, the additional cage body having a first opening configured to receive an additional electronic module (POM), the additional cage body comprising a spring feature, the spring feature configured to apply a biasing pressure to the additional electronic module in a direction away from the printed circuit board and toward the heat dissipating element such that a surface of the additional electronic module contacts the heat dissipating element through a second opening in the additional cage body, the heat dissipating element configured to simultaneously dissipate heat from the electronic module and from the additional electronic module.

12. The electronic module cage of any of clauses 8-11, wherein the heat dissipating element comprises a housing in which the cage body is mounted, the housing having a portion that extends or protrudes through the second opening in the cage body.

13. The electronic module cage of any of clauses 8-12, wherein the printed circuit board (PCB) and the heat dissipating element are located on opposing surfaces of the electronic module cage.

14. The electronic module cage of any of clauses 8-13, wherein the heat dissipating element is a heatsink with at least one active cooling feature.

15. An electronic assembly, comprising: a printed circuit board (PCB) having an electronic module cage mounted thereon, the printed circuit board (PCB) having a heat dissipating element mounted thereon;

the electronic module cage having a cage body having a first opening configured to receive an electronic module (such as a pluggable optical module (POM)), the cage body comprising a spring feature, the spring feature configured to apply a biasing pressure to the electronic module in a direction away from the printed circuit board (PCB) and toward the heat dissipating element such that a surface of the electronic module directly contacts the heat dissipating element through a second opening in the cage body.

16. The electronic assembly of clause 15, wherein the spring feature biases a heat generating surface of the electronic module directly adjacent the heat dissipating element.

17. The electronic assembly of any of clauses 15-16, wherein the heat dissipating element comprises a heat sink solidly affixed to the printed circuit board to which the cage body is mounted.

18. The electronic assembly of any of clauses 15-17, further comprising an additional cage body mounted to the circuit board alongside the cage body, the additional cage body having a first opening configured to receive an additional electronic module (POM), the additional cage body comprising a spring feature, the spring feature configured to apply a biasing pressure to the additional electronic module in a direction away from the printed circuit board and toward the heat dissipating element such that a surface of the additional electronic module contacts the heat dissipating element through a second opening in the additional cage body, the heat dissipating element configured to simultaneously dissipate heat from the electronic module and from the additional electronic module.

19. The electronic assembly of any of clauses 15-18, wherein the heat dissipating element comprises a housing in which the cage body is mounted, the housing having a portion that extends or protrudes through the second opening in the cage body.

20. The electronic assembly of any of clauses 15-19, wherein the printed circuit board (PCB) and the heat dissipating element are located on opposing surfaces of the electronic module cage.

21. The electronic assembly of any of clauses 15-20, wherein the heat dissipating element is a heatsink with at least one active cooling feature.

One or more illustrative or exemplary embodiments of the invention have been described above. However, it is to be understood that the invention is defined by the appended claims and is not limited to the specific embodiments described.

What is claimed is:

1. An electronic module cage for receiving an electronic module (such as a pluggable optical module (POM)), comprising:
a cage body mounted to a printed circuit board (PCB), the cage body having a first opening configured to receive an electronic module, the cage body comprising a spring feature, the spring feature configured to apply a biasing pressure to the electronic module in a direction away from the printed circuit board and toward a heat dissipating element such that a surface of the electronic module contacts the heat dissipating element through a second opening in the cage body.

2. The electronic module cage of claim 1, wherein the spring feature biases a heat generating surface of the electronic module directly adjacent the heat dissipating element.

3. The electronic module cage of claim 1, wherein the heat dissipating element comprises a heat sink solidly affixed to the printed circuit board to which the cage body is mounted.

4. The electronic module cage of claim 1, further comprising an additional cage body mounted to the circuit board alongside the cage body, the additional cage body having a first opening configured to receive an additional electronic module (POM), the additional cage body comprising a spring feature, the spring feature configured to apply a biasing pressure to the additional electronic module in a direction away from the printed circuit board and toward the heat dissipating element such that a surface of the additional electronic module contacts the heat dissipating element through a second opening in the additional cage body, the heat dissipating element configured to simultaneously dissipate heat from the electronic module and from the additional electronic module.

5. The electronic module cage of claim 1, wherein the heat dissipating element comprises a housing in which the cage body is mounted, the housing having a portion that extends or protrudes through the second opening in the cage body.

6. The electronic module cage of claim 1, wherein the printed circuit board (PCB) and the heat dissipating element are located on opposing surfaces of the electronic module cage.

7. The electronic module cage of claim 1, wherein the heat dissipating element is a heatsink with at least one active cooling feature.

8. An electronic module cage for receiving an electronic module (such as a pluggable optical module (POM)), comprising:
a cage body mounted to a printed circuit board (PCB), the cage body having a first opening configured to receive an electronic module, the cage body comprising a spring feature, the spring feature configured to apply a biasing pressure in a direction away from the printed circuit board and toward a heat dissipating element, the heat dissipating element having a portion that extends or protrudes through a second opening in a surface of the cage body.

9. The electronic module cage of claim 8, wherein the spring feature biases a heat generating surface of the electronic module directly adjacent the heat dissipating element.

10. The electronic module cage of claim 8, wherein the heat dissipating element comprises a heat sink solidly affixed to the printed circuit board to which the cage body is mounted.

11. The electronic module cage of claim 8, further comprising an additional cage body mounted to the circuit board alongside the cage body, the additional cage body having a first opening configured to receive an additional electronic module (POM), the additional cage body comprising a spring feature, the spring feature configured to apply a biasing pressure to the additional electronic module in a direction away from the printed circuit board and toward the heat dissipating element such that a surface of the additional electronic module contacts the heat dissipating element through a second opening in the additional cage body, the heat dissipating element configured to simultaneously dissipate heat from the electronic module and from the additional electronic module.

12. The electronic module cage of claim 8, wherein the heat dissipating element comprises a housing in which the cage body is mounted, the housing having a portion that extends or protrudes through the second opening in the cage body.

13. The electronic module cage of claim 8, wherein the printed circuit board (PCB) and the heat dissipating element are located on opposing surfaces of the electronic module cage.

14. The electronic module cage of claim 8, wherein the heat dissipating element is a heatsink with at least one active cooling feature.

15. An electronic assembly, comprising:
a printed circuit board (PCB) having an electronic module cage mounted thereon, the printed circuit board (PCB) having a heat dissipating element mounted thereon;
the electronic module cage having a cage body having a first opening configured to receive an electronic module (such as a pluggable optical module (POM)), the cage body comprising a spring feature, the spring feature configured to apply a biasing pressure to the electronic module in a direction away from the printed circuit board (PCB) and toward the heat dissipating element such that a surface of the electronic module directly contacts the heat dissipating element through a second opening in the cage body.

16. The electronic assembly of claim 15, wherein the spring feature biases a heat generating surface of the electronic module directly adjacent the heat dissipating element.

17. The electronic assembly of claim 15, wherein the heat dissipating element comprises a heat sink solidly affixed to the printed circuit board to which the cage body is mounted.

18. The electronic assembly of claim 15, further comprising an additional cage body mounted to the circuit board alongside the cage body, the additional cage body having a first opening configured to receive an additional electronic module (POM), the additional cage body comprising a spring feature, the spring feature configured to apply a biasing pressure to the additional electronic module in a direction away from the printed circuit board and toward the heat dissipating element such that a surface of the additional electronic module contacts the heat dissipating element through a second opening in the additional cage body, the heat dissipating element configured to simultaneously dissipate heat from the electronic module and from the additional electronic module.

19. The electronic assembly of claim 15, wherein the heat dissipating element comprises a housing in which the cage body is mounted, the housing having a portion that extends or protrudes through the second opening in the cage body.

20. The electronic assembly of claim 15, wherein the printed circuit board (PCB) and the heat dissipating element are located on opposing surfaces of the electronic module cage.

21. The electronic assembly of claim 15, wherein the heat dissipating element is a heatsink with at least one active cooling feature.
